(19) United States
(12) Patent Application Publication
(10) Pub. No.: US 2015/0049128 A1
(43) Pub. Date: Feb. 19, 2015

(54) LIQUID CRYSTAL DRIVE METHOD AND LIQUID CRYSTAL DISPLAY DEVICE

(71) Applicant: Sharp Kabushiki Kaisha, Osaka-shi, Osaka (JP)

(72) Inventors: Yosuke Iwata, Osaka-shi (JP); Mitsuhiro Murata, Osaka-shi (JP)

(21) Appl. No.: 14/388,259

(22) PCT Filed: Mar. 25, 2013
(86) PCT No.: PCT/JP2013/058496

§ 371 Date: Sep. 26, 2014

(30) Foreign Application Priority Data
Mar. 27, 2012 (JP) 2012-072326

(51) Int. Cl. G09G 3/36

(52) U.S. Cl. CPC G09G 3/3607; G09G 2300/043; G09G 2320/0242; G09G 2320/028; G09G 2320/068
USPC 345/690

(57) ABSTRACT

The present invention provides a method for driving a liquid crystal and a liquid crystal display device, wherein a high contrast ratio is achieved even at oblique viewing angles while achieving sufficiently high transmittance during white display. The present invention relates to a method for driving a liquid crystal by generating a potential difference between at least two electrode pairs arranged on upper and lower substrates, the liquid crystal being interposed between the upper and lower substrates and having negative anisotropy of dielectric constant, and the method for driving a liquid crystal including, in the stated order, executing a first driving operation to generate a potential difference between electrodes of a first electrode pair, and executing a second driving operation to generate a potential difference between electrodes of a second electrode pair, the first electrode pair being a pair of electrodes consisting of a first electrode and a second electrode arranged separately on the upper and lower substrates, and the second electrode pair being a pair of electrodes consisting of the second electrode and a third electrode arranged on one of the upper and lower substrates.

### TECHNICAL FIELD

The present invention relates to a method for driving a liquid crystal and a liquid crystal display device. More specifically, the present invention relates to a method for driving a liquid crystal and a liquid crystal display device, wherein display is performed by applying a vertical electric field and a fringe electric field by multiple electrodes.

### BACKGROUND ART

The method for driving a liquid crystal is a means of moving liquid crystal molecules in a liquid crystal layer interposed between a pair of substrates by generating an electric field between electrodes. This allows to change optical characteristics of the liquid crystal layer and thus to control the shielding or transmission of light through a liquid crystal display panel so as to create an on/off state.

Owing to such driving of a liquid crystal, various types of liquid crystal display devices, which exhibit advantages such as thin profile, light weight, and low power consumption, have been provided in various applications. Various driving methods have been invented and put into practical use in displays of devices such as personal computers, televisions, in-vehicle equipment (for example, a car navigation system), and personal digital assistance (for example, a smartphone and a tablet terminal).

Various display modes have been developed for liquid crystal display devices through liquid crystal characteristics, electrode arrangement, substrate design, and the like. Recent common display modes are roughly classified into a vertical alignment (VA) mode in which liquid crystal molecules having negative anisotropy of dielectric constant are aligned perpendicular to the substrate surface; an in-plane switching (IPS) mode and a fringe field switching (FFS) mode in which liquid crystal molecules having positive or negative anisotropy of dielectric constant are aligned horizontally to the substrate surface, and a transverse electric field is applied to the liquid crystal layer; and other modes. Several methods for driving a liquid crystal have been proposed for these display modes.

For example, a liquid crystal display device is disclosed which includes first and second substrates provided facing each other, and a liquid crystal layer including liquid crystal molecules interposed between the first and second substrates, wherein the liquid crystal display device displays an image by changing the orientation of the director of the liquid crystal molecules mainly in a plane parallel to the substrates. This liquid crystal display device further includes a first common electrode provided on the first substrate and configured to receive a first given potential, an insulating film provided on the first common electrode, a pixel electrode provided on the insulating film, and a second common electrode provided on the second substrate and configured to receive a second given potential, wherein the liquid crystal molecules have negative anisotropy of dielectric constant, the pixel electrode has multiple opening portions, and the first common electrode includes at least a specific portion formed on a specific area which extends from a non-opening portion to an opening portion of the pixel electrode and in which the non-opening portion is partially overlapped with the first common electrode in a cross section perpendicular to the substrates (for example, see Patent Literature 1).

Another liquid crystal display device is disclosed which includes two substrates facing each other, a liquid crystal having negative anisotropy of dielectric constant injected between the substrates, a means of applying a first electric field that is substantially perpendicular to the substrate surface, and a means of applying a second electric field that is substantially parallel to the substrate surface, wherein the tilt angle of the liquid crystal molecules relative to the substrate surface is reduced by application of the first electric field, and in this state, the orientation of the liquid crystal molecules is changed by application of the second electric field, whereby an image is displayed in response to changes in the orientation (for example, see Patent Literature 2).

### CITATION LIST

### Patent Literature

Patent Literature 1: JP-A 2000-356786
Patent Literature 2: JP-A 2002-23178

### SUMMARY OF INVENTION

### Technical Problem

Unfortunately, conventional methods for driving a liquid crystal have some room for improvement to provide sufficient contrast at oblique viewing angles in a horizontal alignment type (FFS mode) liquid crystal display device in which a fringe electric field is used (for example, FIG. 16). The shortcoming is due to the fact that while alignment treatment is performed in the liquid crystal display device of the FFS mode in order to align a liquid crystal horizontally in a uniform direction, this treatment makes the liquid crystal molecules to be tilted by several degrees (pre-tilt angle) relative to the substrate surface, and the pre-tilt angle causes light leakage in an oblique direction in a black display state, which decreases contrast at oblique viewing angles.

In addition, according to Patent Literature 1, a first electric field is generated between a first common electrode 400 and a pixel electrode 300, and a second electric field is generated between a second common electrode 500 and the pixel electrode 300 (for example, see FIG. 4 of Patent Literature 1). It is disclosed that when the first electric field and the second electric field are overlapped each other and thus affecting the liquid crystal layer, changes in alignment in a direction perpendicular to the substrates are suppressed, allowing to maintain good alignment in view of optical characteristics, and the liquid crystal molecules are driven in a plane horizontal to the substrates.

Yet, the invention disclosed in Patent Literature 1 is configured such that the first common electrode 400 and the second common electrode 500 have predetermined potentials (constant potentials). In such an invention disclosed in Patent Literature 1, a sufficient potential difference equal to or higher than the potential difference between the first common electrode 400 and the pixel electrode 300 is not applied between the first common electrode 400 and the second common electrode 500, thus failing to sufficiently improve the viewing angle characteristics (see the simulation results of Comparative Example 2 described later).

According to Patent Literature 2, a liquid crystal having negative anisotropy of dielectric constant is used, and the tilt angle of the liquid crystal molecules relative to the substrate surface is reduced by generating a vertical electric field between a pair of electrodes (a vertical electric field electrode 2 and a vertical electric field electrode 9). In this state, the liquid crystal molecules is rotated in a plane horizontal to the substrates by generating a transverse electric field between another pair of electrodes (a transverse electric field electrode 4 and a transverse electric field electrode 5) (for example, see FIG. 1 of Patent Literature 2), thereby improving the viewing angle characteristics.

Yet, in the invention disclosed in Patent Literature 2, an asymmetric and oblique electric field is unfortunately generated because the inter-electrode potential difference between the vertical electric field electrode 2 and the transverse electric field electrode 4 differs from the inter-electrode potential difference between the vertical electric field electrode 2 and the transverse electric field electrode 5, and the liquid crystal molecules are rotated under such a circumstance. As a result, in some cases, high transmittance may not be achieved, and viewing angle characteristic may not be improved (for example, see the simulation results of Comparative Example 3 described later).

The present invention was made in view of the current situation described above, and aims to provide a method for driving a liquid crystal and a liquid crystal display device, wherein a high contrast ratio is achieved even at oblique viewing angles while achieving sufficiently high transmittance during white display.

### Solution to Problem

In regard to a method for driving a liquid crystal and a liquid crystal display device of the FFS mode, wherein display is performed by applying a vertical electric field and a fringe electric field by multiple electrodes, the present inventors examined how to achieve a high contrast ratio even at oblique viewing angles while achieving sufficiently high transmittance during white display. The present inventors focused on using a liquid crystal having negative anisotropy of dielectric constant and arranging a common electrode on the substrate on the opposite side. The present inventors found that, because the director is oriented perpendicular to the lines of electric force in the case where a liquid crystal has negative anisotropy of dielectric constant, the tilt angle of the liquid crystal molecules can be reduced by generating a vertical electric field by establishing a potential difference between a lower layer electrode on a lower substrate and the common electrode on an upper substrate. The present inventors also found that oblique viewing angle characteristics of a liquid crystal display device can be improved while maintaining transmittance, if a fringe electric field is generated in a state where the tilt angle is reduced by application of a vertical electric field so as to allow the liquid crystal molecules to respond and switch in a plane horizontal to the substrates. The present inventors further examined the driving method, and found that the following findings: if a driving operation is first executed to generate an potential difference between electrodes of a first electrode pair consisting of a first electrode and a second electrode respectively arranged on a upper substrate and a lower substrate, and another driving operation is subsequently executed to generate a potential difference between electrodes of a second electrode pair consisting of the second electrode and a third electrode arranged on one of the upper and lower substrates, a suitable electric field can be formed between the two electrode pairs, which results in a high contrast ratio even at oblique viewing angles, thus successfully solving the above-described problems. The present invention was made based on such findings.

The present invention differs from the inventions disclosed in Patent Literatures 1 and 2 in the following points.

Unlike the invention disclosed in Patent Literature 1, the present invention is configured such that a sufficient vertical electric field is also applied to slits by the first electrode pair. As a result, the tilt angle of bulk liquid crystal can be reduced throughout the pixel without depending on the pre-tilt angle, suppressing light leakage at oblique viewing angles and improving the viewing angle characteristics.

Further, unlike the invention disclosed in Patent Literature 2, the present invention is configured such that every upper layer electrode on the lower substrate has the same potential. In other words, the second electrode is used for both first driving and second driving. This allows the liquid crystal molecules to be rotated as designed by a fringe electric field without generating an asymmetric and oblique electric field, thus achieving high transmittance. Owing to the above two advantages, high contrast can be achieved even at oblique viewing angles while maintaining the transmittance.

In other words, the present invention relates to a method for driving a liquid crystal by generating a potential difference between at least two electrode pairs arranged on upper and lower substrates, the liquid crystal being interposed between the upper and lower substrates and having negative anisotropy of dielectric constant, and the method for driving a liquid crystal including, in the stated order, executing a first driving operation to generate a potential difference between electrodes of a first electrode pair, and executing a second driving operation to generate a potential difference between electrodes of a second electrode pair, the first electrode pair being a pair of electrodes consisting of a first electrode and a second electrode arranged separately on the upper and lower substrates, and the second electrode pair being a pair of electrodes consisting of the second electrode and a third electrode arranged on one of the upper and lower substrates.

Preferably, the upper and lower substrates each include an alignment film on main surfaces thereof on the liquid crystal side, the alignment film being configured to align the liquid crystal molecules of the liquid crystal substantially horizontally to the main surfaces of the substrates at a voltage lower than a threshold voltage.

The upper and lower substrates are usually arranged facing each other. Preferably, the first electrode and the second electrode are planar, and the third electrode includes multiple opening portions. Usually, the third electrode including multiple opening portions is an upper layer electrode, and the planar second electrode is a lower layer electrode. It suffices as long as either one of the planar electrode on the lower substrate or the electrode including multiple opening portions is a first common electrode, and the other is a pixel electrode. In the case where the electrode including multiple opening portions on the upper layer is a pixel electrode, a stronger vertical electric field can be applied to the opening portions (slits) on the upper layer electrode. In contrast, in the case where the planar electrode on the lower layer is a pixel electrode, a stronger vertical electric field can be applied to the portions in which the upper layer electrode is formed (i.e., the portions other than the opening portions of the upper layer electrode). Herein, it suffices as long as the planar electrode is one in which at least no opening portion is formed in each pixel unit, i.e., an electrode that is planar in each pixel unit. In the case where the planar electrode on the lower layer is a pixel electrode, it suffices as long as the planar electrode is one in which no opening portion is formed in each pixel unit and in which the opening portions or the like are formed between each pixel unit so that a different voltage can be applied to each pixel unit.

The third electrode is preferably provided on the planar second electrode via an insulating layer. A vertical electric field and a fringe electric field can be suitably applied. Further, the third electrode is preferably a pixel electrode that is independent in each pixel unit.

The first driving operation preferably creates a potential difference between the electrodes of the first electrode pair, the potential difference being equal to or higher than a potential difference applied between the second electrode pair.

The second driving operation is preferably configured to execute a driving operation that applies a fringe electric field between the second electrode pair in a state where an electric field substantially perpendicular to the main surfaces of the substrates is applied between the electrodes of the first electrode pair. The “electric field substantially perpendicular” is preferably an electric field that is oriented relative to the main surfaces of the substrates within a range of 80° to 100°, for example. More preferably, it is an electric field that is considered to be perpendicular to the main surfaces of the substrates in the technical field of the present invention.

Preferably, the liquid crystal molecules of the liquid crystal have a tilt angle relative to the main surfaces of the substrates of more than 0° and less than 20° at a voltage lower than a threshold voltage. The tilt angle refers to a pre-tilt angle described later.

Preferably, the opening portions in the third electrode are provided at constant intervals and allow a symmetric fringe electric field to be applied in a liquid crystal panel. The term “symmetric fringe electric field” encompasses a substantially symmetric fringe electric field that is generated by the electrodes of the present invention.

The opening portions of the third electrode preferably have a width of 2 μm or more and 10 μm or less.

The third electrode is preferably a slit electrode, but may also be formed from multiple electrodes (for example, a pair of comb-shaped electrodes) in which each electrode has a constant voltage. The multiple electrodes may be provided on the same layer, or on different layers as long as the effects of the present invention can be exhibited, but preferably, the multiple electrodes are provided on the same layer. The phrase “the multiple electrodes are provided on the same layer” means that each electrode is in contact with a common member (for example, an insulating layer, a liquid crystal layer, or the like) on the liquid crystal layer side and/or the side opposite to the liquid crystal layer.

The liquid crystal includes liquid crystal molecules that are aligned substantially horizontally to the main surfaces of the substrates at a voltage lower than a threshold voltage. The phrase “the liquid crystal molecules are aligned horizontally to the main surfaces of the substrates” may refer to liquid crystal molecules that are considered to be aligned horizontally to the main surfaces of the substrates in the technical field of the present invention, and encompasses liquid crystal molecules that are substantially horizontally aligned. The liquid crystal is preferably one that substantially consists of liquid crystal molecules that are aligned horizontally to the main surfaces of the substrates at a voltage lower than a threshold voltage.

The threshold voltage refers to, for example, a voltage at which the transmittance is 5% when the transmittance in the bright state is set to 100%. In the case where the third electrode is a pair of comb-shaped electrodes, the width of a comb portion of the pair of comb-shaped electrodes is preferably, for example, 2 μm or more. The width of a gap between comb portions (herein, also referred to as a “space”) is preferably, for example, 2 μm to 10 μm.

Preferably, the liquid crystal substantially consists of liquid crystal molecules having negative anisotropy of dielectric constant.

In the method for driving a liquid crystal of the present invention, the upper and lower substrates each include an alignment film on the main surfaces thereof on the liquid crystal side. Examples of the alignment film include alignment films formed from an organic material and an inorganic material, a photo-alignment film formed from a photoactive material, and an alignment film on which alignment treatment such as rubbing has been performed. The alignment film may be an alignment film on which alignment treatment such as rubbing is not performed. The use of an alignment film such as a photo-alignment film, which does not require alignment treatment, can reduce the cost because it simplifies the process, and can also improve reliability and yield. The use of an a photo-alignment film can also eliminate drawbacks that may occur if rubbing is performed, such as contamination of liquid crystal with a contaminant from rubbing cloth or the like, a dot defect due to foreign matter, and display unevenness due to uneven rubbing in the liquid crystal panel. In addition, preferably, at least one of the upper and lower substrates includes a polarizing plate, on the side opposite to the liquid crystal layer.

Usually, the upper and lower substrates of the liquid crystal display panel of the present invention form one pair of substrates between which the liquid crystal is interposed. For example, the upper and lower substrates can be formed by using an insulating substrate such as glass or a resin as a base material and by forming wires, electrodes, color filters, and the like on the insulating substrate.

Preferably, at least one of the second electrode pair is a pixel electrode, and the substrate including the second electrode pair is an active matrix substrate. In addition, the method for driving a liquid crystal of the present invention is applicable to any of transmissive type, reflective type, and semi-transmissive type liquid crystal display devices.

The present invention also provides a liquid crystal display device that is driven by the method for driving a liquid crystal of the present invention. The liquid crystal display device used in the method for driving a liquid crystal of the present invention can be easily manufactured and can achieve high transmittance and a wide viewing angle. A preferred embodiment of the method for driving a liquid crystal in the liquid crystal display device of the present invention is the same as the above-described preferred embodiment of the method for driving a liquid crystal of the present invention. The liquid crystal display device is particularly preferably applied to, for example, the display or the like a personal digital assistance such as a smartphone and a tablet terminal.

The configurations of the method for driving a liquid crystal and the liquid crystal display device of the present invention are not particularly limited by other elements as long as they essentially include the above-described elements, and other configurations that are usually employed in methods for driving liquid crystal and liquid crystal display devices can be suitably applied to the method for driving a liquid crystal and the liquid crystal display device of the present invention.

### Advantageous Effects of Invention

According to the method for driving a liquid crystal and the liquid crystal display device of the present invention, a high contrast ratio can be achieved even at oblique viewing angles while achieving sufficiently high transmittance during white display by driving the liquid crystal by the first electrode pair and the second electrode pair.

### BRIEF DESCRIPTION OF DRAWINGS

FIG. 1 is a schematic cross-sectional view of a liquid crystal display device during execution of a first driving operation, which is driven by a method for driving a liquid crystal according to Embodiment 1.

FIG. 2 is a schematic cross-sectional view of the liquid crystal display device during execution of a second driving operation, which is driven by the method for driving a liquid crystal according to Embodiment 1.

FIG. 3 is a plan schematic view showing a picture element of the liquid crystal display device driven by the method for driving a liquid crystal according to Embodiment 1.

FIG. 4 is a perspective view showing an orientation angle Aa and a pre-tilt angle Ap of a liquid crystal molecule.

FIG. 5 is a schematic view showing an alignment state of liquid crystal molecules prior to application of a fringe electric field in Embodiment 1.

FIG. 6 is a view showing simulation results of contrast distribution at oblique viewing angles in the liquid crystal display device driven by the method for driving a liquid crystal according to Embodiment 1.

FIG. 7 is a view showing actual measurement results of contrast distribution at oblique viewing angles of the liquid crystal display device driven by the method for driving a liquid crystal according to Embodiment 1.

FIG. 8 is a schematic cross-sectional view of a liquid crystal display device during execution of a first driving operation, which is driven by a method for driving a liquid crystal according to Embodiment 2.

FIG. 9 is a schematic cross-sectional view of the liquid crystal display device during execution of a second driving operation, which is driven by the method for driving a liquid crystal according to Embodiment 2.

FIG. 10 is a view showing simulation results of contrast distribution at oblique viewing angles of the liquid crystal display device driven by the method for driving a liquid crystal according to Embodiment 2.

FIG. 11 is a plan schematic view showing a picture element of a liquid crystal display device driven by a method for driving a liquid crystal according to Embodiment 3.

FIG. 12 is a schematic cross-sectional view of a liquid crystal display device prior to application of a fringe electric field, which is driven by a method for driving a liquid crystal according to Comparative Example 1.

FIG. 13 is a schematic cross-sectional view of the liquid crystal display device after application of the fringe electric field, which is driven by the method for driving a liquid crystal according to Comparative Example 1.

FIG. 14 is a graph showing transmittance characteristics versus voltage applied to pixel electrodes in Embodiment 1 and Comparative Example 1.

FIG. 15 is a schematic view showing an alignment state of liquid crystal molecules prior to application of a fringe electric field in Comparative Example 1.

FIG. 16 is a view showing simulation results of contrast distribution at oblique viewing angles in the liquid crystal display device driven by the method for driving a liquid crystal according to Comparative Example 1.

FIG. 17 is a view showing actual measurement results of contrast distribution at oblique viewing angles in the liquid crystal display device driven by the method for driving a liquid crystal according to Comparative Example 1.

FIG. 18 is a graph showing transmittance versus voltage (V) applied to pixel electrodes in Embodiment 1 and Comparative Example 1.

FIG. 19 is a schematic cross-sectional view of a liquid crystal display device prior to application of a fringe electric field, which is driven by a method for driving a liquid crystal according to Comparative Example 2.

FIG. 20 is a schematic cross-sectional view of the liquid crystal display device after application of the fringe electric field, which is driven by the method for driving a liquid crystal according to Comparative Example 2.

FIG. 21 is a view showing simulation results of contrast distribution at oblique viewing angles in the liquid crystal display device driven by the method for driving a liquid crystal according to Comparative Example 2.

FIG. 22 is a schematic cross-sectional view of a liquid crystal display device prior to application of a fringe electric field, which is driven by a method for driving a liquid crystal according to Comparative Example 3.

FIG. 23 is a schematic cross-sectional view of the liquid crystal display device after application of the fringe electric field, which is driven by the method for driving a liquid crystal according to Comparative Example 3.

FIG. 24 is a view showing simulation results of contrast distribution at oblique viewing angles in the liquid crystal display device driven by the method for driving a liquid crystal according to Comparative Example 3.

FIG. 25 is a graph showing simulation results of transmittance versus voltage (V) applied to pixel electrodes in Embodiments 1 and 2 and Comparative Examples 1 to 3.

### DESCRIPTION OF EMBODIMENTS

The present invention is described below in more detail with reference to the drawing in the following embodiments, but is not limited to these embodiments. As used herein, the term “pixel” may refer to a picture element (subpixel) unless otherwise specified. A pair of substrates interposing a liquid crystal layer therebetween is also referred to as upper and lower substrates. Of these substrates, the one on the display surface side is also referred to as an upper substrate, and the other one on the side opposite to the display surface is also referred to as a lower substrate. Of electrodes arranged on the substrates, the ones on the display surface side are also referred to as upper layer electrodes, and the ones on the side opposite to the display surface are also referred to as lower layer electrodes.

In addition, a circuit substrate (for example, the lower substrate) of the present embodiment is also referred to as a TFT substrate or an array substrate because it includes a thin film transistor element (TFT) or the like. The lower substrate is also referred to as a first substrate, and the upper substrate is also referred to as a second substrate. The upper and lower substrates are usually arranged facing each other.

Throughout the embodiments, members and portions that exhibit similar functions are donated by the same reference signs. In the drawing, V1 to V11 each indicate a voltage applied to the electrodes unless otherwise specified. The reference potential is indicated by “0V”.

### Embodiment 1

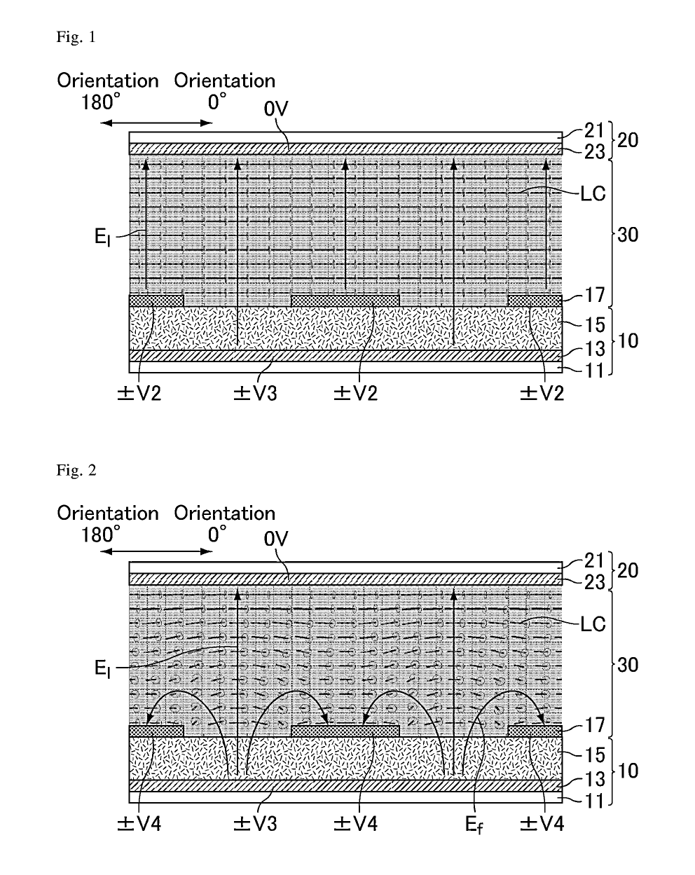

FIG. 1 is a schematic cross-sectional view of a liquid crystal display device during execution of a first driving operation, which is driven by a method for driving a liquid crystal according to Embodiment 1. FIG. 2 is a schematic cross-sectional view of the liquid crystal display device during execution of a second driving operation, which is driven by the method for driving a liquid crystal according to Embodiment 1. These figures show the configuration of the liquid crystal display device of Embodiment 1 and the voltage applied to each electrode. The lines of electric force (vertical electric field El) indicate the direction (orientation of an electric field to be generated) when the applied voltage has a positive polarity.

In a liquid crystal layer 30, a liquid crystal LC having negative anisotropy of dielectric constant is used. In other words, the liquid crystal display device according to Embodiment 1 has a horizontal alignment type three-layer electrode structure in which liquid crystal molecules LC (negative type liquid crystal) are used (herein, an upper layer electrode 17 on the lower substrate, which is on the second layer, is an electrode having slits (slit electrode)).

In other words, in the liquid crystal display device according to Embodiment 1, a lower substrate 10 includes two layers of electrodes via an insulating layer 15 therebetween, and the upper layer electrode 17 is provided with multiple slits. A lower layer electrode 13 is a planar electrode. As described later, a potential difference is created between the lower layer electrode 13 and the upper layer electrode 17 to generate a fringe electric field. Herein, as shown in the drawing of the present application (for example, FIG. 1, FIG. 2, and elsewhere), the upper layer electrode 17 may be a pixel electrode, and the lower layer electrode 13 maybe a common electrode. In contrast, the upper layer electrode 17 may be a common electrode, and the lower layer electrode 13 may be a pixel electrode.

Embodiment 1 also includes, in addition to the above-described two-layer electrode structure of the lower substrate 10 for generating the above-described fringe electric field, a planar common electrode 23 arranged on a counter substrate 20, and uses a liquid crystal having negative anisotropy of dielectric constant. In the method for driving a liquid crystal of Embodiment 1, display is performed by adjusting the transmittance by changing the orientation of the director of the horizontally aligned liquid crystal by the fringe electric field.

First, in a first driving operation, as shown in FIG. 1, the liquid crystal molecules are rotated by a vertical electric field generated by a potential difference V3 between the lower layer electrode (common electrode) 13 on the lower substrate 10 and the common electrode 23 on the upper substrate (counter substrate) 20, and a potential difference V2 between the upper layer electrode 17 on the lower substrate 10 and the common electrode 23 on the upper substrate 20. Herein, the vertical electric field is an electric field substantially perpendicular to the main surfaces of the substrates within a range of 80° to 100°. At this point, the liquid crystal display device is in a black display state. The potential difference (V3−V2) between the lower layer electrode 13 on the lower substrate 10 and the upper layer electrode 17 on the lower substrate 10 is small, thus not generating a sufficient fringe electric field. The potential difference (V3−V2) can be set to, for example, 0 V to 2 V.

Next, in a second driving operation, as shown in FIG. 2, the potential of the upper layer electrode 17 on the lower substrate 10 is changed from ±V2 to ±V4 so as to generate a fringe electric field. In other words, white display is performed by changing the orientation of the director of the liquid crystal molecules LC by the fringe electric field that is generated by a potential difference (V3−V4) between the upper layer electrode 17 and the lower layer electrode (common electrode) 13 on the lower substrate 10, while the vertical electric field is applied which is generated by the potential difference V3 between the lower layer electrode 13 on the lower substrate 10 and the common electrode 23 on the upper substrate 20.

In the method for driving a liquid crystal in Embodiment 1, |V3|≧|V2|≧|V4|. For example, |V2| can be 0 V to 20 V, |V3| can be 3 V to 20 V, and |V4| can be 0 V to 15 V.

In the first driving operation, the potential difference V3 is created between the lower layer electrode (common electrode) 13 on the lower substrate 10 and the common electrode 23 on the upper substrate 20 so as to generate a sufficiently high vertical electric field (i.e., a potential difference is applied which is equal to or higher than the potential difference (V3−V2) between the lower layer electrode (common electrode) 13 and the upper layer electrode (pixel electrode) 17 on the lower substrate 10). In the case of a liquid crystal having negative anisotropy of dielectric constant, the director is oriented perpendicular to the lines of electric force, so that the tilt angle of the liquid crystal molecules can be reduced, and light leakage at oblique viewing angles in a black display state can also be reduced. Thus, it is possible to improve the viewing angle characteristics by generating a fringe electric field in a state where the tilt angle is reduced by a vertical electric field and by allowing the liquid crystal molecules to respond in a plane horizontal to the substrates.

The transmittance characteristics versus voltage in Embodiment 1 are as shown by the line indicated by Embodiment 1 in FIG. 14 described later.

The liquid crystal display device according to Embodiment 1 is configured in such a manner that the lower substrate 10, the liquid crystal layer 30, and the upper substrate 20 (color filter substrate) are stacked in the stated order from the back side of the liquid crystal display panel to the viewing side. The planar lower layer electrode 13 (common electrode 13) is formed in such a manner that the insulating layer 15 is sandwiched between the planar lower layer electrode 13 and the upper layer electrode 17 provided with multiple slits as described above. For example, an oxide film SiO2, a nitride film SiN, an acrylic resin, or the like is used as the insulating layer 15. A combination of these materials can also be used.

Although not shown in FIG. 1 or FIG. 2, a polarizing plate is arranged on each substrate, on the side opposite to the liquid crystal layer. As the polarizing plate, either a circularly polarizing plate or a linearly polarizing plate can be used. In addition, an alignment film is arranged on the liquid crystal layer side of each substrate, and these alignment films may be either organic alignment films or inorganic alignment films as long as these films align the liquid crystal molecules substantially horizontally to the film surface.

At a timing selected by a scanning signal line, a voltage supplied from a video signal line is applied to the upper layer electrode 17 that drives the liquid crystal, through a thin film transistor element (TFT). The upper layer electrode 17 is connected to a drain electrode extending from the TFT via a contact hole. In FIG. 1 and FIG. 2, the lower layer electrode 13 and the common electrode 23 are planar, and the common electrode 23 is connected in common to all the pixels. The lower layer electrode 13 is configured to have no opening portion in each pixel unit. The lower layer electrode 13 may be independently provided to each pixel or may be connected in common to every line of pixels to allow each pixel or each line of pixels to be individually driven through polarity inversion; or the lower layer electrode 13 may be connected in common to all the pixels. In the case where the lower layer electrode 13 is a pixel electrode, the lower layer electrode 13 is formed to have an opening or the like between each pixel unit so that a different voltage can be applied to each pixel unit.

The cell gap (thickness of the liquid crystal layer) is set to 3.2 μm, but it can take any value as long as it is 2 μm to 7 μm. The cell gap in the above range is preferred. As used herein, the cell gap is preferably calculated by averaging all thicknesses of the liquid crystal layer in the liquid crystal display panel.

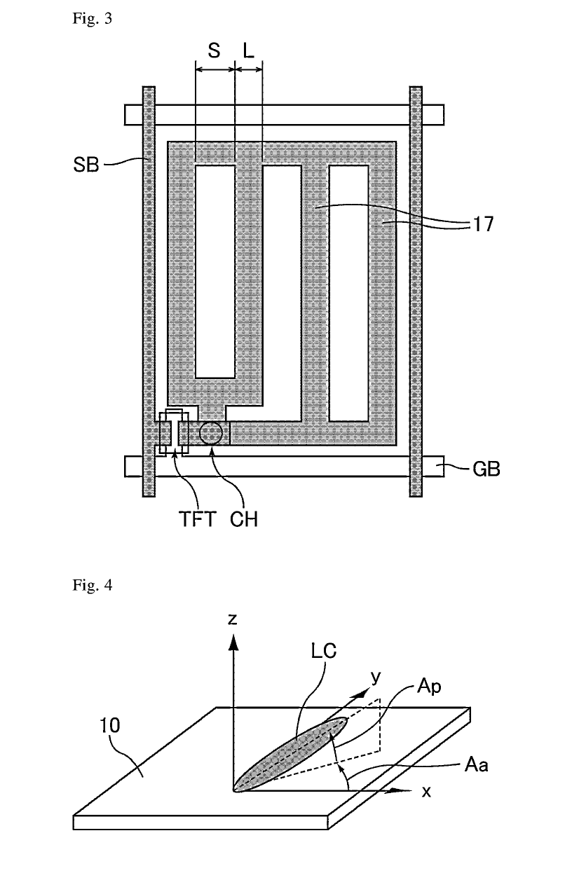

FIG. 3 is a plan schematic view showing a picture element of the liquid crystal display device driven by the method for driving a liquid crystal according to Embodiment 1. In Embodiment 1, a slit electrode provided with multiple slits is used as the pixel electrode (upper layer electrode 17). “S” is the inter-electrode gap (width of the opening portion), and “L” is the electrode width.

In the present embodiment, the electrode width L of the upper layer electrode is set to 3 μm. It is preferably 2 μm or more. It is also preferably 10 μm or less. The inter-electrode gap S of the slit electrode is set to 3 μm. It is preferably 2 μm or more. It is also preferably 10 μm or less. The ratio of the electrode width L to the inter-electrode gap S (L/S) is preferably 0.2 to 5, for example. The lower limit is more preferably 0.3, and the upper limit is more preferably 3.

FIG. 4 is a perspective view showing an orientation angle Aa and a pre-tilt angle Ap of a liquid crystal molecule. The orientation angle Aa of the liquid crystal molecule refers to an orientation angle which is an angle in the x-y plane. The pre-tilt angle refers to an angle at a voltage lower than a threshold voltage. The tilt angle refers to an angle similar to the pre-tilt angle shown in FIG. 4. Unlike the pre-tilt angle, the tilt angle is not limited to an angle at a voltage lower than a threshold voltage. In Embodiment 1, the pre-tilt angle is 2.5°, but it can take any value as long as it is more than 0° and is 20° or less. More preferably, it is 2° or more and 10° or less.

It should be noted that even if an attempt is made to reduce the pre-tilt angle in advance, it will be difficult to achieve effects equivalent to those of the present invention. In other words, if alignment treatment is performed on the horizontal alignment film by rubbing, it will be difficult to achieve a pre-tilt angle of 2° or less due to manufacturing problems. In addition, usually, in order to achieve an intended initial alignment, a certain degree of the pre-tilt angle is needed to define the alignment direction of the liquid crystal molecules. Thus, it is considered that the effects equivalent to those of the present invention cannot be achieved through attempts to adjust the pre-tilt angle to close to 0° simply by rubbing without applying a vertical electric field.

The orientation angle of the liquid crystal molecules under no voltage application is set to 7°. It is preferably 3° or more, and is also preferably 15° or less.

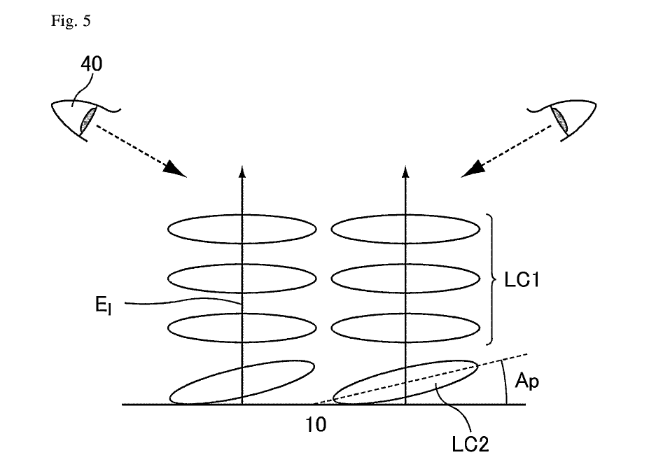

FIG. 5 is a schematic view showing an alignment state of liquid crystal molecules prior to application of a fringe electric field in Embodiment 1. As shown in FIG. 5, in the configuration of Embodiment 1, the bulk liquid crystal molecules LC1 are not tilted. In other words, the following can be achieved: (1) a difference in alignment depending on the viewing angle orientation is eliminated, allowing to obtain more symmetric viewing angle characteristics; and (2) because the liquid crystal is almost completely horizontally aligned, sufficient optical compensation can be achieved, allowing to markedly reduce light leakage in black display.

The bulk liquid crystal molecules LC1 will respond to the vertical electric field in Embodiment 1, eliminating the tilt angle. A liquid crystal molecule LC2 in the vicinity of the interface with the liquid crystal layer of the lower substrate 10 (or the upper substrate) is tilted by a degree of the pre-tilt angle.

In the case where the anisotropy of dielectric constant is positive, the liquid crystal would rise up. Thus, the present embodiment uses a liquid crystal having negative anisotropy of dielectric constant.

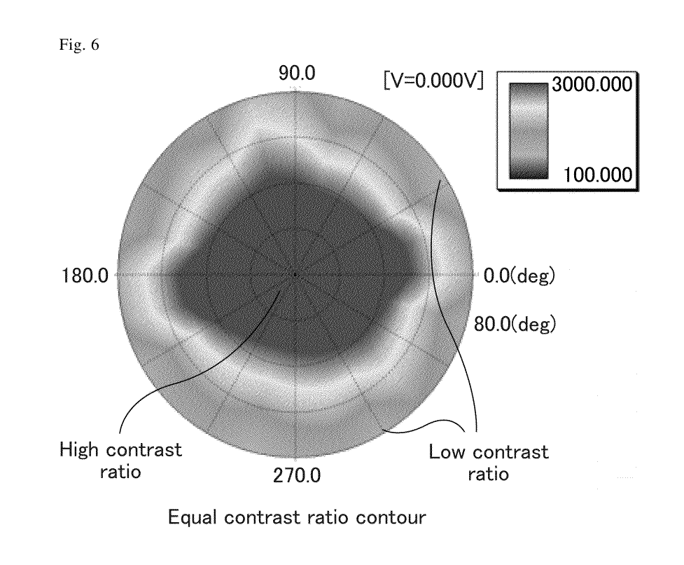

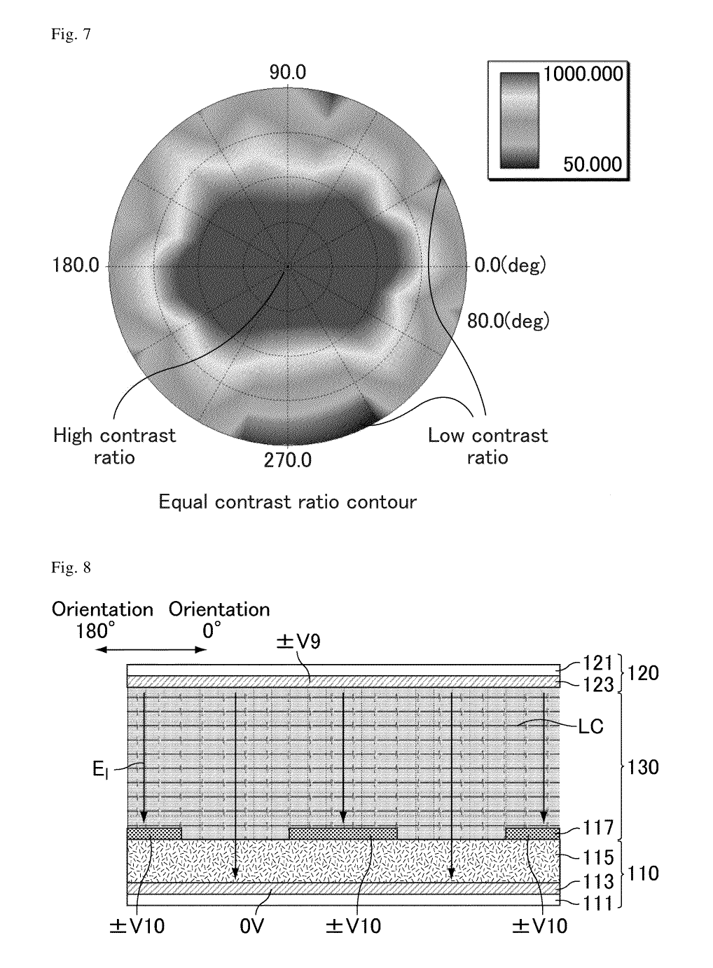

FIG. 6 is a view showing simulation results of contrast distribution at oblique viewing angles in the liquid crystal display device driven by the method for driving a liquid crystal according to Embodiment 1. FIG. 6 shows contrast distribution in the configuration of the liquid crystal display device of Embodiment 1 when the pre-tilt angle is 2.5°. FIG. 7 is a view showing actual measurement results of contrast distribution at oblique viewing angles of the liquid crystal display device driven by the method for driving a liquid crystal according to Embodiment 1. Embodiment 1 achieves high contrast in all directions.

The liquid crystal display device driven by the method for driving a liquid crystal in Embodiment 1 can suitably include members (such as a light source) which are included in usual liquid crystal display devices. The same applies to other embodiments described later.

### Embodiment 2

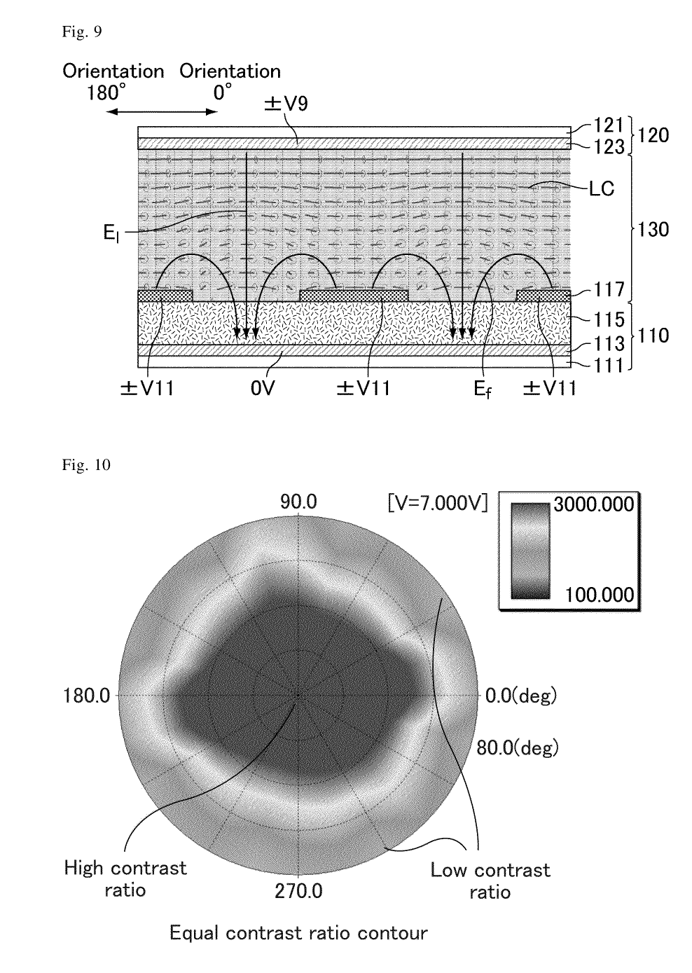

FIG. 8 is a schematic cross-sectional view of a liquid crystal display device during execution of the first driving operation, which is driven by a method for driving a liquid crystal according to Embodiment 2. FIG. 9 is a schematic cross-sectional view of the liquid crystal display device during execution of the second driving operation, which is driven by the method for driving a liquid crystal according to Embodiment 2.

These figures show the configuration of the liquid crystal display device of Embodiment 2 and the voltage applied to each electrode. The lines of electric force (vertical electric field El) indicate the direction of the electric field when the applied voltage has a positive polarity. Also in Embodiment 2, a liquid crystal having negative anisotropy of dielectric constant is used.

In Embodiment 1 described above, the common electrode on the upper substrate is set to 0 V, and in that state, a voltage is applied to the lower layer electrode (common electrode) on the lower substrate to generate a vertical electric field, and further, the voltage of the slit electrode on the upper layer of the lower substrate is changed so as to perform driving. In Embodiment 2, a lower layer electrode (common electrode) 113 on a lower substrate 110 is set to 0 V, and in that state, a voltage ±V9 is applied to a common electrode 123 on a upper substrate (counter substrate) 120 to generate a vertical electric field, and further, the voltage of a upper layer electrode 117 (electrode provided with multiple slits) on the lower substrate 110 is changed from ±V10 to ±V11 so as to perform driving.

In the method for driving a liquid crystal of Embodiment 2, the conditions are as follows: |V9|≧|V11|≧|V10|. For example, |V9| can be 3 V to 20 V, |V10| can be 0 V to 10 V, and 1V11| can be 0 V to 15 V.

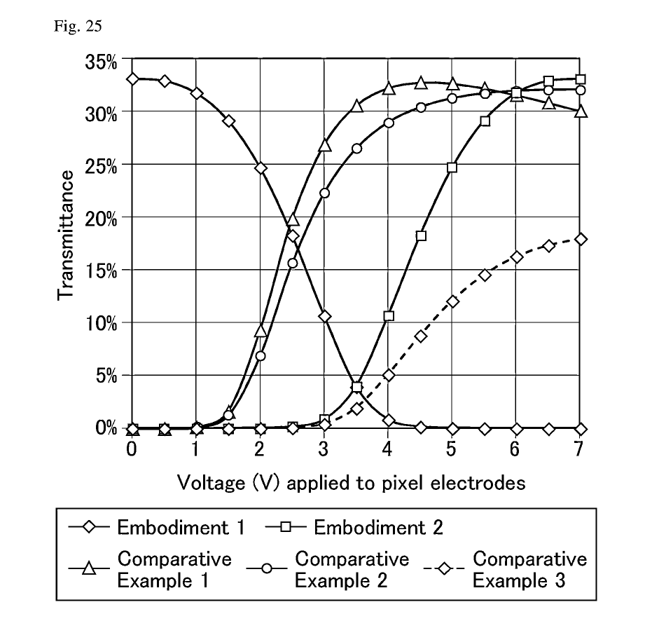

Table 2 and FIG. 25 show the simulation results of transmittance characteristics versus voltage at the front of the device in Embodiment 2. The maximum transmittance in Embodiment 2 is also equal to that in Embodiment 1.

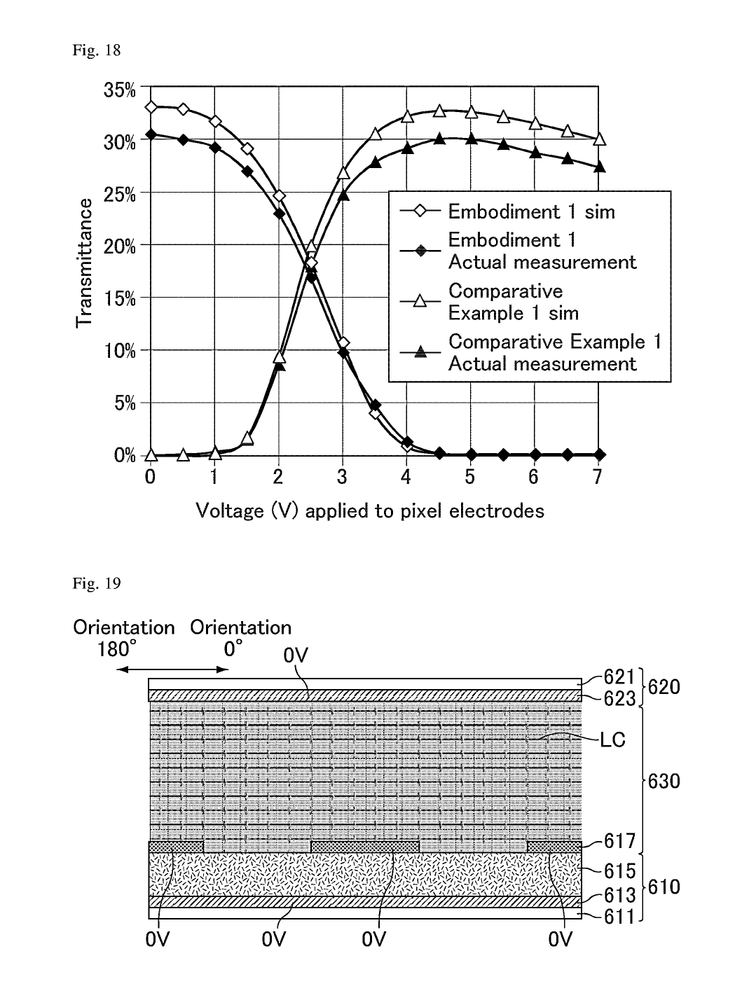

Herein, all of the following conditions in Embodiment 2 are the same as those in Embodiment 1 as well as in Comparative Examples 1 to 3 described later: liquid crystal material, thickness of the liquid crystal layer (3.2 μm), thickness of the insulating layer (0.3 μm), electrode width (3 μm), inter-electrode gap (3 μm), pre-tilt angle (2.5°) of the liquid crystal molecules, and orientation angle (7°) of the liquid crystal molecules under no voltage application. In addition, in each embodiment and each comparative example, the device used for simulation was “LCD-MASTER” available from Shintec Company Limited, and calculations were performed under the above-described conditions. Further, the voltage of the common electrode to apply a vertical electric field was set to V3=V6=V9=7.5 V in both simulations and actual measurements. The voltage applied to the pixel electrode was changed as shown by the horizontal axis in FIG. 18 or FIG. 25. In addition, in each embodiment and each comparative example, the polarizing plate (not shown) arranged on each glass substrate, on the side opposite to the liquid crystal layer, of both upper and lower substrates is a linearly polarizing plate. The polarizing plates are arranged in in crossed Nicols such that the polarization axis on one substrate is parallel to the orientation (7°) in which the liquid crystal molecules are horizontally aligned, and the polarization axis on the other substrate is perpendicular to the orientation.

FIG. 10 is a view showing simulation results of contrast distribution at oblique viewing angles of the liquid crystal display device driven by the method for driving a liquid crystal according to Embodiment 2.

As in the case of Embodiment 1, Embodiment 2 also achieved high contrast in all directions, compared to Comparative Examples 1 to 3 described later. The reason why the improvement effect is obtained is as described in Embodiment 1.

The method for applying a voltage to each electrode is different between Embodiment 1 and Embodiment 2. However, according to simulations in which calculations are performed under ideal conditions, the electric field distribution when the maximum transmittance is obtained (during white display) is substantially identical between these embodiments, except that the polarity is different. Thus, the alignment state of the liquid crystal molecules is also substantially identical between these embodiments. As a result, FIG. 6 and FIG. 10 each showing simulation results of contrast distribution in Embodiment 1 and Embodiment 2, respectively, are substantially identical to each other.

Other configurations of Embodiment 2 are the same as those described in Embodiment 1. The other reference signs in the figures relating to Embodiment 2 are the same as those in the figures relating to Embodiment 1, except that 1 is in the hundreds place.

### Embodiment 3

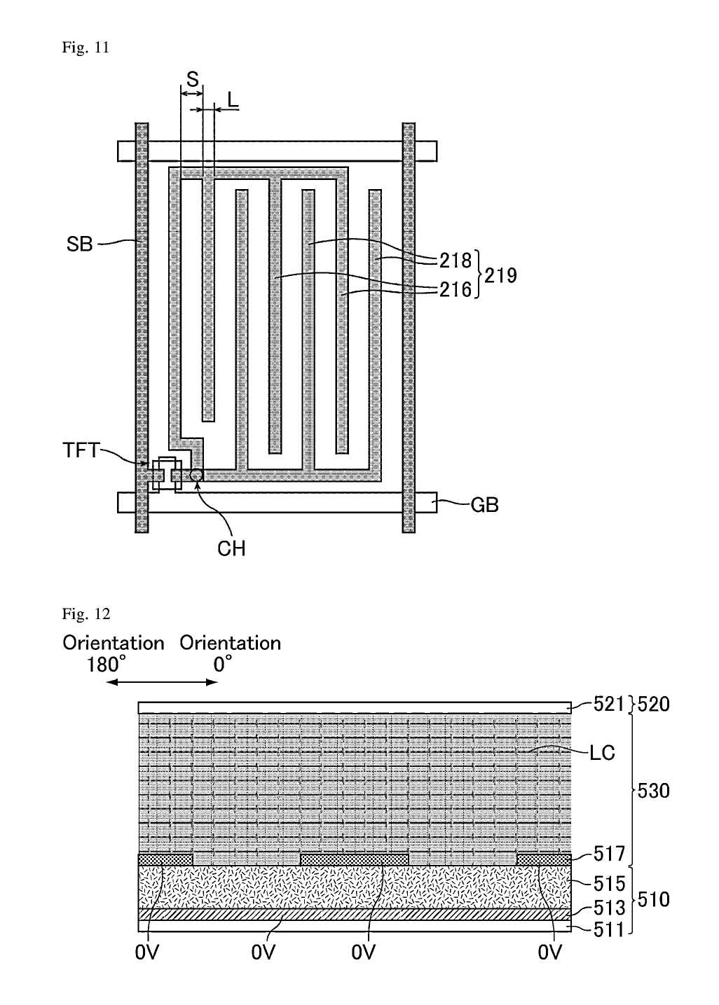

FIG. 11 is a plan schematic view showing a picture element of a liquid crystal display device driven by a method for driving a liquid crystal according to Embodiment 3. As shown, in Embodiment 3, a pair of comb-shaped electrodes 219 having the same potential is used as the upper layer electrode, instead of the electrode provided with multiple slits.

In the present embodiment, a comb electrode portion 216 and a comb electrode portion 218 are formed on the same layer, and it is preferred that these members be formed on the same layer. Yet, these members may be formed on different layers as long as the effects of the present invention can be achieved.

Other configurations of Embodiment 3 are the same as those described in Embodiment 1. The other reference signs in the figures relating to Embodiment 3 are the same as those in the figures relating to Embodiment 1, except that 2 is in the hundreds place.

The electrode structure and the like in the liquid crystal display panel and the liquid crystal display device of the present invention can be confirmed on the TFT substrate and the counter substrate by microscopic observation using a scanning electron microscope (SEM) or the like.

### COMPARATIVE EXAMPLE 1

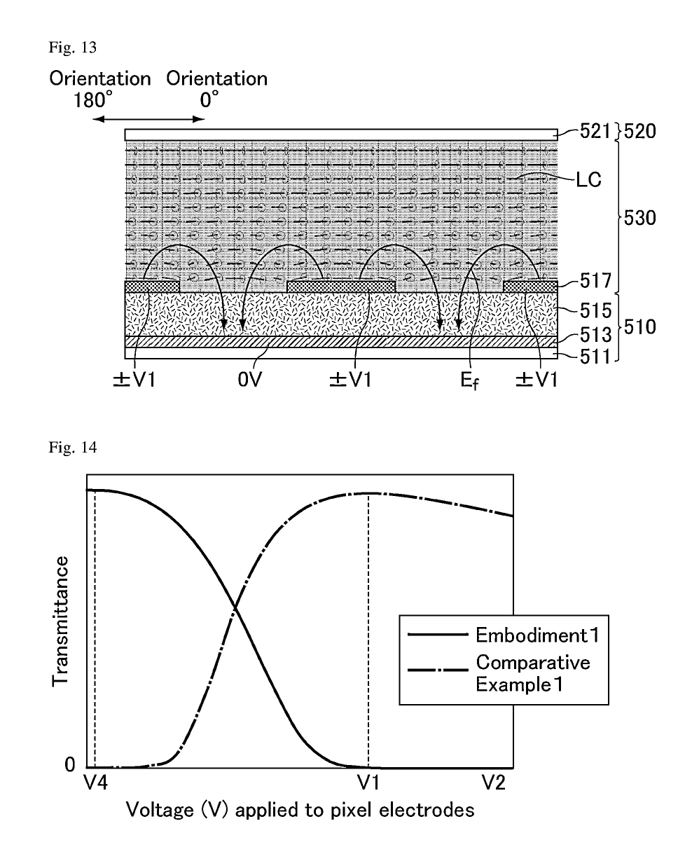

FIG. 12 is a schematic cross-sectional view of a liquid crystal display device prior to application of a fringe electric field, which is driven by a method for driving a liquid crystal according to Comparative Example 1. FIG. 13 is a schematic cross-sectional view of the liquid crystal display device after application of the fringe electric field, which is driven by the method for driving a liquid crystal according to Comparative Example 1. These figures show a general FFS mode configuration and the voltage applied to each electrode. Also in Comparative Example 1, a liquid crystal having negative anisotropy of dielectric constant is used.

In the liquid crystal display device of the FFS mode, alignment treatment is performed in order to align the liquid crystal horizontally in a uniform direction. At this point, the liquid crystal molecules are pre-tilted by several degrees (for example, more than 0° and less than)20° relative to the substrate surface. In Comparative Example 1, the pre-tilt angle causes light leakage in an oblique direction in a black display state, which in turn decreases contrast at oblique viewing angles. FIG. 14 is a graph showing transmittance characteristics versus voltage applied to the pixel electrodes in Embodiment 1 and Comparative Example 1. FIG. 14 is a view schematically showing a relationship between applied voltage and transmittance, and a difference in the effect between Embodiment 1 and Comparative Example 1 is omitted in the figure.

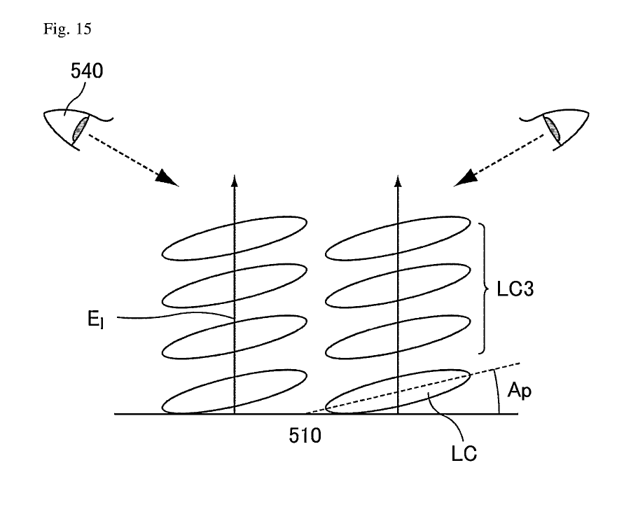

FIG. 15 is a schematic view showing an alignment state of liquid crystal molecules prior to application of a fringe electric field in Comparative Example 1. FIG. 15 shows a case where the liquid crystal molecules are tilted in a general FFS mode. As shown in FIG. 15, in the configuration of Comparative Example 1, bulk liquid crystal molecules LC3 are also pre-tilted by the same degrees as the liquid crystal molecule LC in the vicinity of the interface with the liquid crystal layer of a lower substrate 510 (or the upper substrate). In other words, the following problems will arise: (1) the alignment differs depending on the viewing angle orientation, resulting in asymmetric viewing angle characteristics; and (2) because the liquid crystal is not completely horizontally aligned, sufficient optical compensation cannot be achieved, causing light leakage during black display.

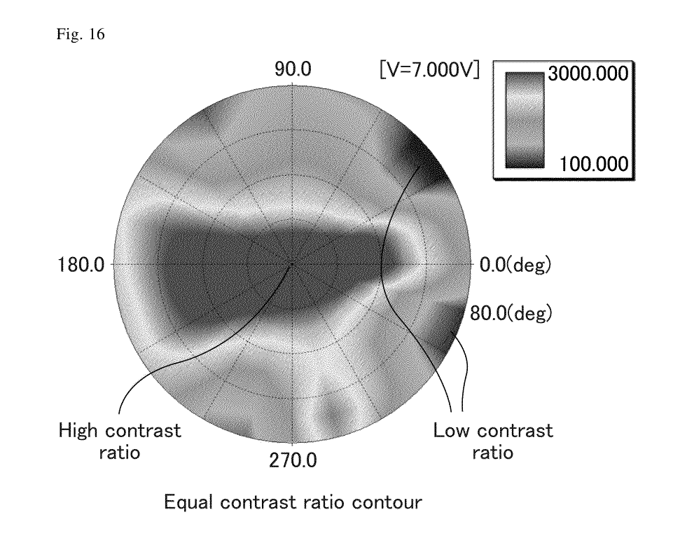

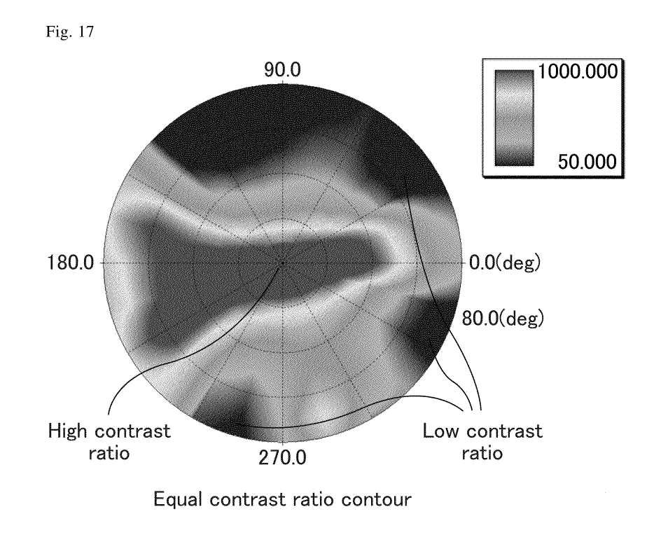

FIG. 16 is a view showing simulation results of contrast distribution at oblique viewing angles in the liquid crystal display device driven by the method for driving a liquid crystal according to Comparative Example 1. FIG. 16 shows contrast distribution in the FFS mode when the pre-tilt angle is 2.5°. FIG. 17 is a view showing actual measurement results of contrast distribution at oblique viewing angles in the liquid crystal display device driven by the method for driving a liquid crystal according to Comparative Example 1. Comparative Example 1 does not achieve high contrast in all directions. In other words, as shown in FIGS. 6 and 7 and FIGS. 16 and 17 described above which respectively show contrast distributions at oblique viewing angles in Embodiment 1 and Comparative Example 1, the simulation results and the actual measurement results of contrast distribution show similar tendency. It is clear that high contrast is achieved in all directions in Embodiment 1, compared to Comparative Example 1, in both simulations and actual measurements. It should be noted that the reason why the absolute contrast values from actual measurements are lower than the simulation results is because light leakage occurs during black display in actual measurements due to thermal fluctuation of the liquid crystal and margin of error in the design during manufacturing, whereas such thermal fluctuation of the liquid crystal and margin of error in the design during manufacturing are disregarded in simulations.

### COMPARATIVE BETWEEN EMBODIMENT 1 AND COMPARATIVE EXAMPLE 1

The following Table 1 and FIG. 18 are a table and a graph showing transmittance versus voltage (V) applied to the pixel electrodes in Embodiment 1 and Comparative Example 1. FIG. 18 shows transmittance characteristics versus voltage at the front of the device. The same liquid crystal material (Δε=−5, Δn=0.11) was used in Embodiment 1 and Comparative Example 1, and the anisotropy of dielectric constant was negative. The thickness of the liquid crystal layer was set to 3.2 μm, the thickness of the insulating layer was set to 0.3 μm, and the electrode width and the inter-electrode gap (slit width) were both set to 3 μm. The pre-tilt angle of the liquid crystal molecules was 2.5°, and the liquid crystal molecules under no voltage application were uniformly aligned at an orientation angle of 7°. The simulation results and the actual measurement values of the transmittance showed similar tendency. Comparison shows that the maximum transmittance was higher in Embodiment 1 than in Comparative Example 1 in both calculated results and actual measurements.

TABLE 1

| Voltage | Transmittance | | | |
|---|---|---|---|---|
| applied to | Embodiment 1 | | Comparative Example 1 | |
| pixel electrodes | | Actual | | Actual |
| (V) | Simulation | measurement | Simulation | measurement |
| 0 | 33.1% | 30.5% | 0.0% | 0.0% |
| 0.5 | 32.9% | 29.9% | 0.0% | 0.1% |
| 1 | 31.7% | 29.2% | 0.2% | 0.4% |
| 1.5 | 29.1% | 27.0% | 1.6% | 1.5% |
| 2 | 24.7% | 23.0% | 9.3% | 8.5% |
| 2.5 | 18.3% | 16.8% | 19.9% | 17.9% |
| 3 | 10.7% | 9.7% | 26.9% | 24.7% |
| 3.5 | 4.0% | 4.7% | 30.5% | 27.8% |
| 4 | 0.8% | 1.2% | 32.2% | 29.1% |
| 4.5 | 0.2% | 0.1% | 32.7% | 30.0% |
| 5 | 0.0% | 0.0% | 32.6% | 30.0% |
| 5.5 | 0.0% | 0.0% | 32.2% | 29.5% |
| 6 | 0.0% | 0.0% | 31.6% | 28.7% |
| 6.5 | 0.0% | 0.0% | 30.8% | 28.2% |
| 7 | 0.0% | 0.1% | 30.0% | 27.4% |

In Embodiment 1, because a sufficiently high vertical electric field is applied between the common electrodes on the upper and lower substrates, changes in alignment in a direction perpendicular to the substrates are suppressed, and the liquid crystal molecules are driven in a plane that is more horizontal to the substrates, thus resulting in better optical characteristics, compared to Comparative Example 1.

### COMPARATIVE EXAMPLE 2

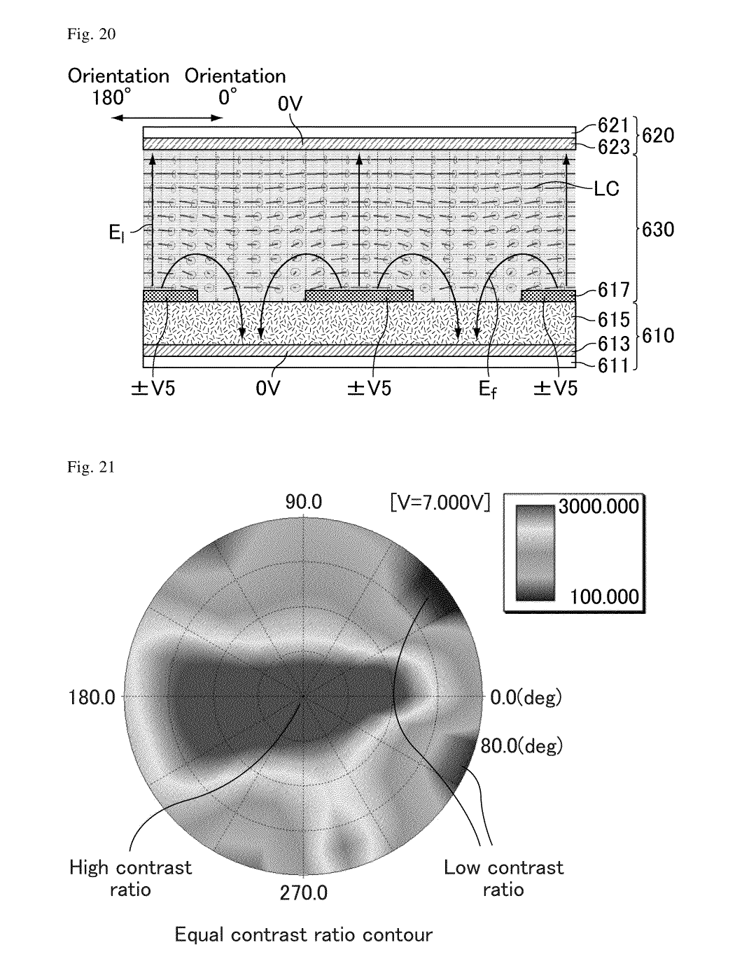

FIG. 19 is a schematic cross-sectional view of a liquid crystal display device prior to application of a fringe electric field, which is driven by a method for driving a liquid crystal according to Comparative Example 2. FIG. 20 is a schematic cross-sectional view of the liquid crystal display device after application of the fringe electric field, which is driven by the method for driving a liquid crystal according to Comparative Example 2.

Comparative Example 2 corresponds to the configuration and the driving method disclosed in Patent Literature 1 mentioned above and JP-A 2009-229599. In Comparative Example 2, a lower layer electrode (common electrode) 613 on a lower substrate 610 and a common electrode 623 on an upper substrate 620 have the same potential. A liquid crystal having negative anisotropy of dielectric constant is used.

In order to show the effects of the present invention, comparison was made among the present invention, a general FFS mode, and the prior art in terms of characteristics achieved by these configurations and driving methods.

In short, Embodiment 1 is an example of the configuration and the driving method of the present invention. Comparative Example 1 corresponds to a general FFS mode in which no electrode is arranged on the counter substrate. Comparative Example 2 corresponds to a device in which the configuration is the same as that of Embodiment 1 but the common electrode on the lower substrate and the common electrode on the upper substrate are set to have the same potential (0 V) as in the case of the prior art (invention disclosed in JP-A 2000-356786). Differences from Embodiment 1 areas follows: (1) no vertical electric field is present between the substrates during black display; and (2) no vertical electric field is generated over the slits even during white (halftone) display (see FIG. 20).

FIG. 21 is a view showing simulation results of contrast distribution at oblique viewing angles in the liquid crystal display device driven by the method for driving a liquid crystal according to Comparative Example 2. Comparative Example 2 does not achieve high contrast in all directions.

It should be noted that Comparative Example 1 and Comparative Example 2 each show the results obtained under circumstances where the effect of the present invention to reduce the tilt angle of the bulk liquid crystal is not exhibited and where the liquid crystal molecules are simply rotated by the fringe electric field. Therefore, the simulation results of contrast distribution in these comparative examples shown in FIG. 16 and FIG. 21 appear to be identical. However, the exact alignment state is different between Comparative Example 1 and Comparative Example 2, as a difference in the maximum transmittance value can be confirmed between these comparative examples in FIG. 25 or Table 2. In other words, in this case, although these figures appear to be identical, the results are actually slightly different.

### COMPARATIVE EXAMPLE 3

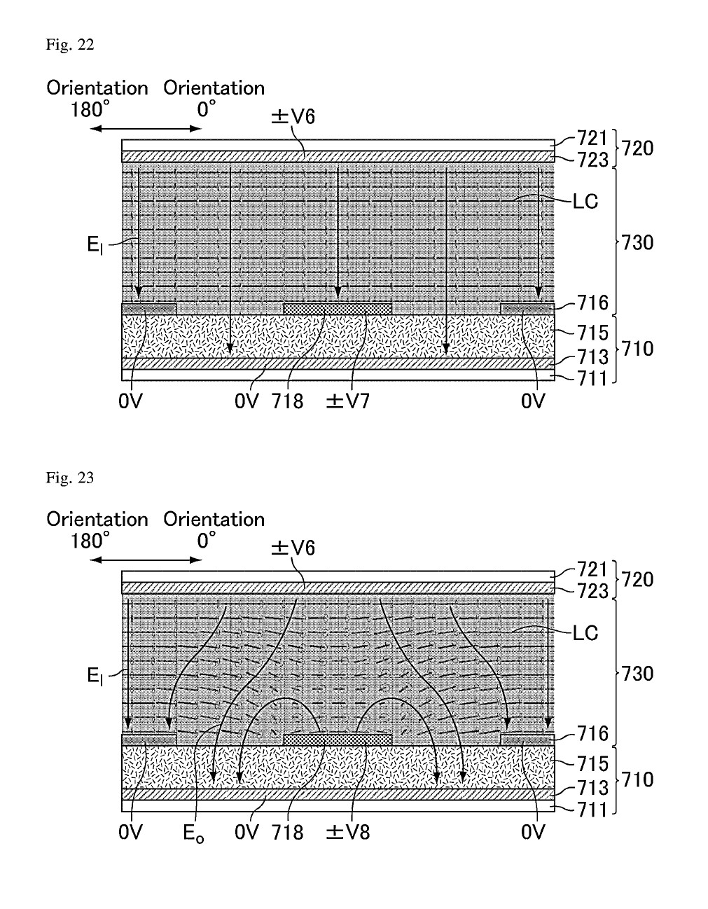

FIG. 22 is a schematic cross-sectional view of a liquid crystal display device prior to application of a fringe electric field, which is driven by a method for driving a liquid crystal according to Comparative Example 3. FIG. 23 is a schematic cross-sectional view of the liquid crystal display device after application of the fringe electric field, which is driven by the method for driving a liquid crystal according to Comparative Example 3.

Comparative Example 3 shows the configuration and the driving method disclosed in Patent Literature 2 mentioned above. In the method for driving a liquid crystal of Comparative Example 3, the conditions are as follows: |V6|≧|V8|≧|V7|. In addition, a liquid crystal having negative anisotropy of dielectric constant is used. In the figure, the lines of electric force indicate the direction of the electric force when the applied voltage has a positive polarity.

In Comparative Example 3, a pixel electrode 718 and a common electrode 716 are arranged in a comb shape on the upper layer of the lower substrate, and a potential difference is applied between these electrodes. A difference from Embodiment 1 is that an asymmetric and oblique electric field is generated instead of a transverse electric field or a fringe electric field during white (halftone) display because the potential difference between a common electrode 713 and the pixel electrode 718 is different from the potential difference between the common electrode 713 and the common electrode 716 on the lower substrate (see FIG. 23).

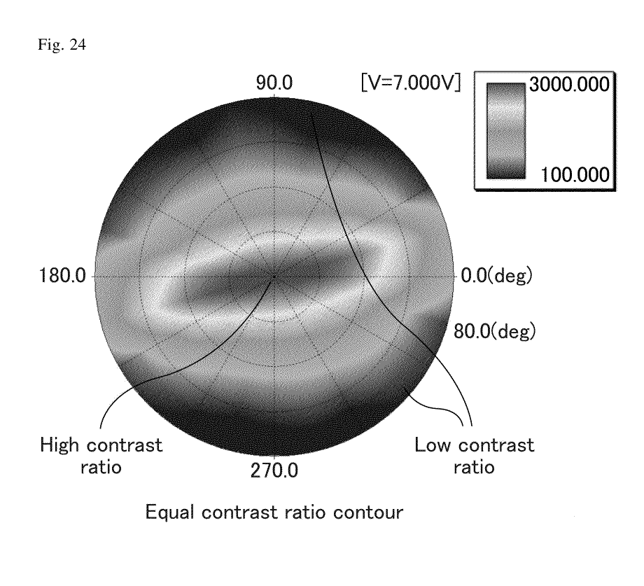

FIG. 24 is a view showing simulation results of contrast distribution at oblique viewing angles in the liquid crystal display device driven by the method for driving a liquid crystal according to Comparative Example 3. Comparative Example 3 also does not achieve high contrast in all directions.

### Comparison between Embodiments 1 and 2 and Comparative Examples 2 and 3

The following Table 2 and FIG. 25 are a table and a graph showing the simulation results of transmittance versus voltage (V) applied to the pixel electrodes in Embodiments 1 and 2 and Comparative Examples 1 to 3.

The simulation results of transmittance characteristics versus voltage at the front of the device in Embodiments 1 and 2 and Comparative Examples 1 to 3 are shown. The same liquid crystal material (Δε=−5, Δn=0.11) was used, and the anisotropy of dielectric constant was negative. The thickness of the liquid crystal layer was set to 3.2 μm, the thickness of the insulating layer was set to 0.3 μm, and the electrode width and the inter-electrode gap were both set to 3 μm. The pre-tilt angle of the liquid crystal molecules was 2.5°, and the liquid crystal molecules under no voltage application were uniformly aligned at an orientation angle of 7°. Comparison of the maximum transmittance in Embodiment 1 and Comparative Examples 1 to 3 showed that Embodiment 1 achieved a highest value.

TABLE 2

| Voltage | | | | | |
|---|---|---|---|---|---|
| applied to | Transmittance | | | | |
| pixel electrodes | | | Comparative | Comparative | Comparative |
| (V) | Embodiment 1 | Embodiment 2 | Example 1 | Example 2 | Example 3 |
| 0 | 33.1% | 0.0% | 0.0% | 0.0% | 0.0% |
| 0.5 | 32.9% | 0.0% | 0.0% | 0.0% | 0.0% |
| 1 | 31.7% | 0.0% | 0.2% | 0.1% | 0.0% |
| 1.5 | 29.1% | 0.0% | 1.6% | 1.3% | 0.0% |
| 2 | 24.7% | 0.0% | 9.3% | 6.9% | 0.0% |
| 2.5 | 18.3% | 0.2% | 19.9% | 15.6% | 0.1% |
| 3 | 10.7% | 0.8% | 26.9% | 22.3% | 0.4% |
| 3.5 | 4.0% | 3.9% | 30.5% | 26.5% | 1.9% |
| 4 | 0.8% | 10.6% | 32.2% | 29.0% | 5.1% |
| 4.5 | 0.2% | 18.3% | 32.7% | 30.4% | 8.8% |
| 5 | 0.0% | 24.7% | 32.6% | 31.2% | 12.1% |
| 5.5 | 0.0% | 29.1% | 32.2% | 31.7% | 14.6% |
| 6 | 0.0% | 31.7% | 31.6% | 32.0% | 16.3% |
| 6.5 | 0.0% | 32.9% | 30.8% | 32.1% | 17.3% |
| 7 | 0.0% | 33.1% | 30.0% | 32.1% | 18.0% |

The contrast distribution at oblique viewing angles in Comparative Examples 2 and 3 are as shown in FIG. 21 and FIG. 24, respectively. It is clear that Embodiment 1 (FIG. 6 and FIG. 7) achieves high contrast in all directions, compared to Comparative Examples 2 and 3.

The driving method of Comparative Example 2 allows a vertical electric field to be generated between the common electrode and the pixel electrode on the counter substrate as in the case of Embodiment 1, achieving the effect of reducing the tilt angle. However, the tilt angle of the liquid crystal molecules over the slits cannot be reduced because no vertical electric field is generated between the common electrodes on the upper and lower substrates. As a result, neither transmittance nor contrast at oblique viewing angles is improved. Thus, these characteristics are similar or inferior to those obtained by a general FFS mode (Comparative Example 1).

In Comparative Example 3, the pixel electrode and the common electrode are arranged in a comb shape on the upper layer of the lower substrate, and a potential difference is created between these electrodes. Therefore, the symmetric electric field distribution does not occur in the liquid crystal panel, and an oblique electric field is generated instead of a fringe electric field in some places. The asymmetric electric field distribution creates an area where the liquid crystal molecules are not driven in a plane horizontal to the substrates, resulting in poor transmittance and contrast at oblique viewing angles, compared to a general FFS mode (Comparative Example 1).

### Other Embodiments

As a TFT semiconductor, an oxide semiconductor such as IGZO (In—Ga—Zn—O) can be suitably used, in addition to an a-Si (amorphous silicon) semiconductor. The use of an oxide semiconductor as a semiconductor layer of the TFT element can reduce the size of the TFT element, compared to the case where an amorphous silicon is used. Thus, an oxide semiconductor is suitable to a high-definition liquid crystal display. In particular, an In—Ga—Zn—O-based semiconductor (IGZO) is more preferred.

The liquid crystal display device of the present embodiment achieves certain effects when combined with the oxide semiconductor TFT described above. Yet, it is also possible to drive the liquid crystal display device using a publicly known TFT element such as an amorphous silicon TFT or a polycrystalline silicon TFT.

### REFERENCE SIGNS LIST

10, 110, 210, 510, 610: lower substrate 11, 21, 111, 121, 211, 221, 511, 521: glass substrate 13, 113, 213, 513: lower layer electrode 15, 115, 215, 515: insulating layer 17, 117, 217, 517: upper layer electrode 20, 120, 220, 520: upper substrate (counter substrate) 30, 130, 230, 530: liquid crystal layer 216, 218: comb electrode portion 219: a pair of comb-shaped electrodes 23, 123, 623, 713, 716: common electrode 718: pixel electrode LC: liquid crystal (liquid crystal molecules)

1. A method for driving a liquid crystal by generating a potential difference between at least two electrode pairs arranged on upper and lower substrates,
the liquid crystal being interposed between the upper and lower substrates and having negative anisotropy of dielectric constant,
the method for driving a liquid crystal comprising, in the stated order:
executing a first driving operation to generate a potential difference between electrodes of a first electrode pair; and
executing a second driving operation to generate a potential difference between electrodes of a second electrode pair,
the first electrode pair being a pair of electrodes consisting of a first electrode and a second electrode arranged separately on the upper and lower substrates, and the second electrode pair being a pair of electrodes consisting of the second electrode and a third electrode arranged on one of the upper and lower substrates.

2. The method for driving a liquid crystal according to claim 1,
wherein the upper and lower substrates each comprise an alignment film on main surfaces thereof on the liquid crystal side, the alignment film being configured to align liquid crystal molecules of the liquid crystal substantially horizontally to the main surfaces of the substrates at a voltage lower than a threshold voltage.

3. The method for driving a liquid crystal according to claim 1,
wherein the first electrode and the second electrode are planar, and
the third electrode comprises multiple opening portions.

4. The method for driving a liquid crystal according to claim 1,
wherein the third electrode is provided on the second electrode via an insulating layer.

5. The method for driving a liquid crystal according to claim 1,
wherein the first driving operation creates a potential difference between the electrodes of the first electrode pair, the potential difference being equal to or higher than a potential difference applied between the second electrode pair.

6. The method for driving a liquid crystal according to claim 1,
wherein the second driving operation applies a fringe electric field between the second electrode pair in a state where an electric field substantially perpendicular to the main surfaces of the substrates is applied between the electrodes of the first electrode pair.

7. The method for driving a liquid crystal according to claim 1,
wherein the liquid crystal molecules of the liquid crystal have a tilt angle relative to the main surfaces of the substrates of more than 0° and less than 20° at a voltage lower than a threshold voltage.

8. The method for driving a liquid crystal according to claim 3,
wherein the opening portions in the third electrode are provided at constant intervals and allow a symmetric fringe electric field to be applied in a liquid crystal panel.

9. The method for driving a liquid crystal according to claim 3,
wherein the opening portions of the third electrode have a width of 2 μm or more and 10 μm or less.

10. A liquid crystal display device driven by the method for driving a liquid crystal as defined in claim 1.
